(19) United States
(12) Patent Application Publication
(10) Pub. No.: US 2025/0267489 A1
(43) Pub. Date: Aug. 21, 2025

(54) INFORMATION PROCESSING METHOD AND APPARATUS, COMMUNICATION DEVICE, AND STORAGE MEDIUM

(71) Applicant: Beijing Xiaomi Mobile Software Co., Ltd., Beijing (CN)

(72) Inventor: Xuhua TAO, Beijing (CN)

(73) Assignee: Beijing Xiaomi Mobile Software Co., Ltd., Beijing (CN)

(21) Appl. No.: 18/847,013

(22) PCT Filed: Mar. 14, 2022
(86) PCT No.: PCT/CN2022/080775

§ 371 Date: Sep. 13, 2024

(51) Int. Cl. H04W 24/10; H04W 88/06

(52) U.S. Cl. CPC H04W 24/10; H04W 88/06

(57) ABSTRACT

Embodiments of the present disclosure provide an information processing method and apparatus, a communication device, and a storage medium. The information processing method performed by a first access device may comprise: performing communication of measurement gap information for a dual-connectivity user equipment (UE) with a second access device.

### CROSS REFERENCE TO RELATED APPLICATION

The application is the U.S. National Stage of International Application No. PCT/CN2022/080775, filed on Mar. 14, 2022, the entire content of which is incorporated herein by reference for all purposes.

### TECHNICAL FIELD

The present disclosure relates to, but is not limited to, the technical field of wireless communication, and in particular, to an information processing method and apparatus, a communication device and a storage medium.

### BACKGROUND

A measurement gap may be used for a user equipment (UE) to measure a synchronization signal PBCH block (SSB) and a channel state information-reference signal (CSI-RS). PBCH is the abbreviation of physical broadcast channel, and is translated as physical broadcast channel. It is defined in the related art that one frequency range (FR) may be configured with an independent configuration gap, and one FR may be configured with two sets of measurement gaps.

### SUMMARY

Embodiments of the present disclosure provide an information processing method and apparatus, a communication device, and a storage medium.

A first aspect provided by the embodiments of the present disclosure provides an information processing method, where the method is performed by a first access device and the method includes:
performing communication of measurement gap information for a dual-connectivity user equipment (UE) with a second access device.

A second aspect of the embodiments of the present disclosure provides an information processing method, where the method is performed by a dual-connectivity UE, and the method includes:
in response to a sum of a number of sets Z of measurement gap configurations sent by a first access device and a number of sets Y of measurement gap configurations sent by a second access device being greater than a number of sets X of measurement gap configurations supported by the dual-connectivity UE, discarding at least one set of measurement gap configuration sent by an access device of a primary secondary cell.

A third aspect of the embodiments of the present disclosure provides an information processing apparatus, where the apparatus includes:
a communication module, configured to perform communication of measurement gap information for a dual-connectivity user equipment (UE) with a second access device.

A fourth aspect of the embodiments of the present disclosure provides an information processing apparatus, where the apparatus includes:
a discarding module, configured to, in response to a sum of a number of sets Z of measurement gap configurations sent by a first access device and a number of sets Y of measurement gap configurations sent by a second access device being greater than a number of sets X of measurement gap configurations supported by a dual-connectivity UE, discard at least one set of measurement gap configuration sent by an access device of a primary secondary cell.

A fifth aspect of the embodiments of the present disclosure provides a communication device, including a processor, a transceiver, a memory, and an executable program stored in the memory and capable of being run by the processor, where the processor executes the information processing method provided in the first or second aspect when running the executable program.

A sixth aspect of the embodiments of the present disclosure provides a computer storage medium, with an executable program stored thereon, where the executable program is able to implement the method provided in the first aspect or the second aspect after being executed by a processor.

According to the technical solutions provided by the embodiments of the present disclosure, two access devices of the dual-connectivity UE may exchange measurement gap information for the same dual-connectivity UE, thereby reducing the problem that the capability of the UE cannot support the execution of measurements of multiple sets of measurement gaps due to the fact that the two access devices both configure measurement gaps for the UE individually, and enhancing the adaptability of the configuration of the measurement gaps for the dual-connectivity UE.

It should be understood that the foregoing general description and the following detailed description are exemplary and explanatory only and do not limit the embodiments of the present disclosure.

### BRIEF DESCRIPTION OF THE DRAWINGS

The accompanying drawings herein, which are incorporated in and constitute a part of the specification, illustrate embodiments consistent with the present disclosure and are used in conjunction with the specification to explain principles of the embodiments of the present disclosure.

FIG. 1 is a schematic structural diagram of a wireless communication system according to an exemplary embodiment;

FIG. 2 is a schematic flow chart of an information processing method according to an exemplary embodiment;

FIG. 3A is a schematic flow chart of an information processing method according to an exemplary embodiment;

FIG. 3B is a schematic flow chart of an information processing method according to an exemplary embodiment;

FIG. 4A is a schematic flow chart of an information processing method according to an exemplary embodiment;

FIG. 4B is a schematic flow chart of an information processing method according to an exemplary embodiment;

FIG. 5A is a schematic flow chart of an information processing method according to an exemplary embodiment;

FIG. 5B is a schematic flow chart of an information processing method according to an exemplary embodiment;

FIG. 6 is a schematic flow chart of an information processing method according to an exemplary embodiment;

FIG. 7A is a schematic flow chart of an information processing method according to an exemplary embodiment;

FIG. 7B is a schematic flow chart of an information processing method according to an exemplary embodiment;

FIG. 8 is a schematic structural diagram of an information processing apparatus according to an exemplary embodiment;

FIG. 9 is a schematic structural diagram of an information processing apparatus according to an exemplary embodiment;

FIG. 10 is a schematic structural diagram of a UE according to an exemplary embodiment; and

FIG. 11 is a schematic structural diagram of a communication device according to an exemplary embodiment.

### DETAILED DESCRIPTION

Exemplary embodiments will be described in detail herein, examples of which are represented in the accompanying drawings. When the following description relates to the drawings, the same numerals in different accompanying drawings represent the same or similar elements unless otherwise indicated. The implementations described in the following exemplary embodiments do not represent all implementations consistent with the embodiments of the present disclosure. To the contrary, they are merely examples of apparatuses and methods that are consistent with some aspects of the embodiments of the present disclosure.

Terms used in the embodiments of the present disclosure are used solely for the purpose of describing certain embodiments and are not intended to limit the embodiments of the present disclosure. The singular forms of “a/an” and “the” used in the present disclosure are also intended to include plural forms unless the context clearly indicates other meanings. It should also be understood that the term “and/or” used herein refers to and includes any or all possible combinations of one or more associated listed items.

It should be understood that although the terms first, second, third, etc. may be used to describe various information in the embodiments of the present disclosure, such information should not be limited to these terms. These terms are only used to distinguish the same type of information from each other. For example, without departing from the scope of the embodiments of the present disclosure, the first information may also be referred to as the second information, and similarly, the second information may also be referred to as the first information. Depending on the context, the word “if” as used herein may be interpreted as “when . . . ” or “in the case . . . ” or “in response to determination”.

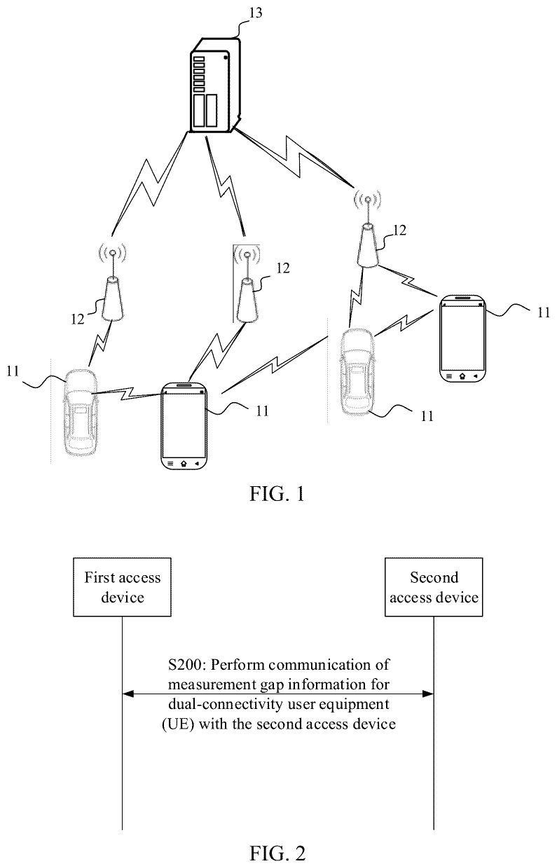

Referring to FIG. 1, a schematic structural diagram of a wireless communication system provided by an embodiment of the present disclosure is illustrated. As shown in FIG. 1, the wireless communication system is a communication system based on cellular mobile communication technology, and the wireless communication system may include: several UEs 11 and several access devices 12.

The UE 11 may refer to a device that provides voice and/or data connectivity to a user. The UE 11 may communicate with one or more core networks via a radio access network (RAN). The UE 11 may be an IoT terminal, such as a sensor device, a mobile phone (or referred to as a “cellular” phone), and a computer with an IoT terminal, for example, it may be a fixed, portable, pocket-sized, handheld, computer-built-in, or vehicle-mounted apparatus, e.g., a station (STA), a subscriber unit, a subscriber station, a mobile station, a mobile, a remote station, an access point, a remote UE (remote terminal), an access UE (access terminal), a user terminal, a user agent, a user device or a user equipment (UE). Alternatively, the UE 11 may be a device of an unmanned aerial vehicle. Alternatively, the UE 11 may be a vehicle-mounted device, for example, it may be a trip computer with a wireless communication function, or a wireless communication device externally connected to a trip computer. Alternatively, the UE 11 may be a roadside device, for example, a street lamp, a signal lamp, or other roadside device with a wireless communication function.

The access device 12 may be a network side device in a wireless communication system. The wireless communication system may be the 4th generation mobile communication technology (4G) system, also known as a long term evolution (LTE) system; or, the wireless communication system may be a 5G system, also known as a new radio (NR) system or a 5G NR system. Alternatively, the wireless communication system may be a next generation system after the 5G system. The access network in the 5G system may be referred to as a new generation-radio access network (NG-RAN). Or, it may be an MTC system.

The access device 12 may be an evolved access device (eNB) used in a 4G system. Alternatively, the access device 12 may also be an access device (gNB) using a centralized and distributed architecture in a 5G system. When the access device 12 uses the centralized and distributed architecture, it usually includes a central unit (CU) and at least two distributed units (DU). The central unit is provided with protocol stacks of a packet data convergence protocol (PDCP) layer, a radio link layer control protocol (Radio Link Control, RLC) layer, and a media access control (MAC) layer; and the distributed unit is provided with a protocol stack of a physical (PHY) layer. The specific implementation manner of the access device 12 is not limited by the embodiments of the present disclosure.

A wireless connection may be established between the access device 12 and the UE 11 through a wireless air interface. In different implementations, the wireless air interface is a wireless air interface based on the fourth generation mobile communication network technology (4G) standard; or, the wireless air interface is a wireless air interface based on the fifth generation mobile communication network technology (5G) standard, for example, the wireless air interface is a new air interface; or, the wireless air interface may also be a wireless air interface based on the next generation mobile communication network technology standard after 5G.

As shown in FIG. 2, an embodiment of the present disclosure provides an information processing method, which is performed by a first access device and the method includes the following.

In step S200, communication of measurement gap information for dual-connectivity user equipment (UE) is performed with a second access device.

In the embodiments of the present disclosure, the first access device may be various types of base stations, for example, an evolved base station (eNB), a next generation base station (gNB), etc.

Exemplarily, the dual-connectivity UE may be a multi-radio access technology dual connectivity (MR-DC) UE.

Exemplarily, the MR-DC technology may include an NR-E-UTRA dual connectivity (NE-DC), an E-UTRA-NR dual connectivity (EN-DC), and an NR-NR dual connectivity (NR-DC), which is not limited in the present disclosure.

The first access device herein may be an access device of a primary cell (Pcell) of the dual-connectivity UE, or an access device of a primary secondary cell (Pscell) of the dual-connectivity UE.

In some embodiments, the step S200 may include at least one of the following:
receiving measurement gap information of the dual-connectivity UE sent by the second access device; or
sending measurement gap information of the dual-connectivity UE to the second access device.

The measurement gap information may be: information indicating the measurement gap configured for the dual-connectivity UE. Exemplarily, the measurement gap information at least indicates: a number of sets of measurement gaps configured by the first access device for the dual-connectivity UE, and/or a number of sets of measurement gaps configured by the second access device for the dual-connectivity UE.

Depending on whether the measurement gap is shared by multiple FRs, the measurement gaps may be divided into:

an independent measurement gap, and/or a shared measurement gap.

The independent measurement gap is used for measurement of only one FR.

The shared measurement gap is used for measurements of two or more FRs.

The number of sets of measurement gaps here may be: the total number of sets of the independent measurement gaps and/or the shared measurement gaps configured for the dual-connectivity UE, and/or the number of sets of the independent measurement gaps configured for the dual-connectivity UE.

In other embodiments, the measurement gap information is not limited to indicating the number of sets of measurement gaps configured by the first access device and/or the second access device for the dual connectivity, but may also be a specific measurement gap configuration. In this way, the first access device may configure the measurement gap for the dual-connectivity UE by referring to the measurement gap configuration of the second access device for the dual-connectivity UE, and/or the second access device may configure the measurement gap for the dual-connectivity UE by referring to the measurement gap configuration of the first access device for the dual-connectivity UE, thereby ensuring that the measurement gaps configured for the dual-connectivity UE by the two access devices are applicable to the dual-connectivity UE.

Specifically, the step S200 may include: configuring the measurement gap for the dual-connectivity UE according to a capability of the dual-connectivity UE supporting the measurement gap and the measurement gap information configured by the second access device for the dual-connectivity UE.

In this way, the two access devices of the dual-connectivity UE may exchange measurement gap information for the same dual-connectivity UE, thereby reducing the problem that the capability of the UE cannot support the execution of measurements of multiple sets of measurement gaps due to the fact that the two access devices both configure measurement gaps for the UE individually, and enhancing the adaptability of the configuration of the measurement gaps for the dual-connectivity UE.

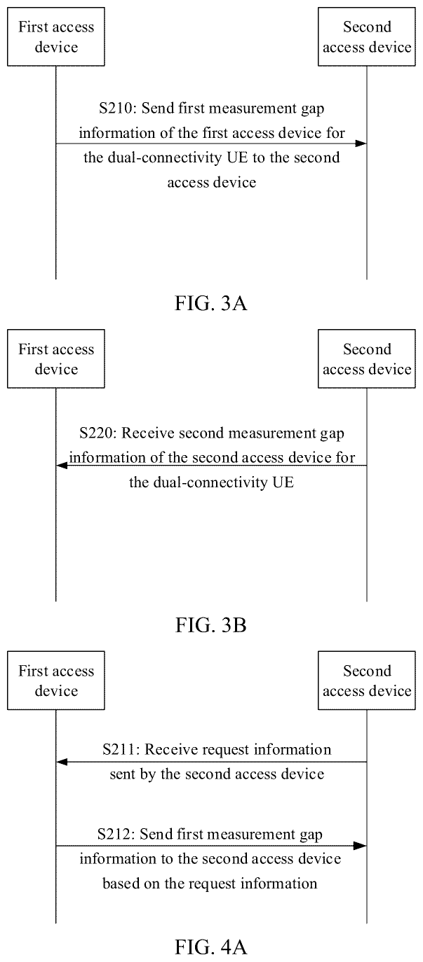

As shown in FIG. 3A, an embodiment of the present disclosure provides an information processing method, which is performed by a first access device and the method includes the following.

In step S210, first measurement gap information of the first access device for the dual-connectivity UE is sent to the second access device.

The first measurement gap information at least indicates: a number of sets of measurement gaps configured by the first access device for the dual-connectivity UE.

In this way, the first measurement gap information may be used by the second access device to determine a number of sets of measurement gaps configured for the dual-connectivity UE according to a number of sets of measurement gaps supported by the dual-connectivity UE and the number of sets of measurement gaps configured for the dual-connectivity UE by the first access device.

In some embodiments, the first measurement gap information may also indicate: a measurement gap of the first access device for the dual-connectivity UE; in this way, the second access device may also configure the measurement gap for the dual-connectivity UE according to the specific configuration of the measurement gap of the first access device for the dual-connectivity UE.

As shown in FIG. 3B, an embodiment of the present disclosure provides an information processing method, which is performed by a first access device and the method includes the following.

In step S220: second measurement gap information of the second access device for the dual-connectivity UE is received.

The second measurement gap information at least indicates: a number of sets of measurement gaps configured by the second access device for the dual-connectivity UE.

In this way, the second measurement gap information may be used by the first access device to determine a number of sets of measurement gaps configured for the dual-connectivity UE according to a number of sets of measurement gaps supported by the dual-connectivity UE and the number of sets of measurement gaps configured for the dual-connectivity UE by the second access device.

In some embodiments, the second measurement gap information may also indicate: the measurement gap of the second access device for the dual-connectivity UE; in this way, the first access device may also configure the measurement gap for the dual-connectivity UE according to the specific configuration of the measurement gap of the second access device for the dual-connectivity UE.

In some embodiments, the step S210 may include: sending the first measurement gap information to the second access device after generating a measurement gap configuration for the dual-connectivity UE.

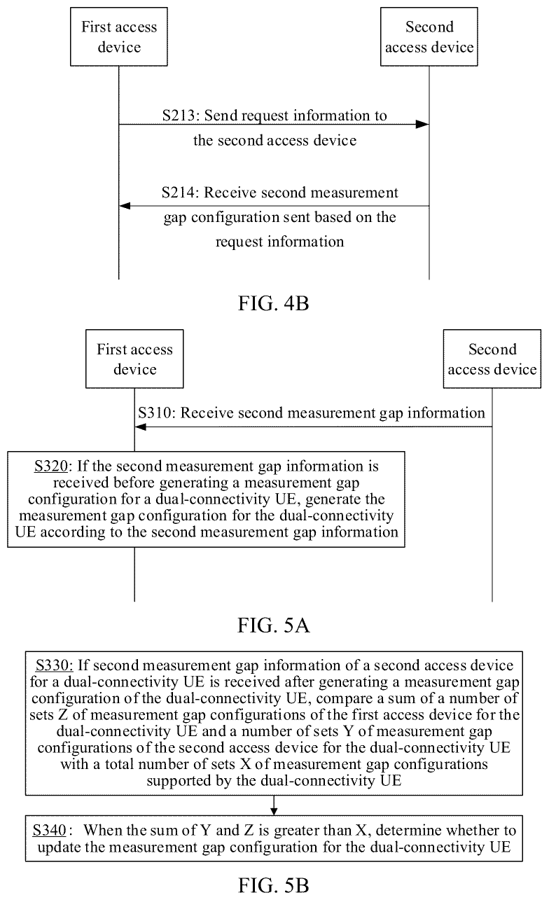

As shown in FIG. 4A, an embodiment of the present disclosure provides an information processing method, which is performed by a first access device, and the method may include the following steps.

In step S211, request information sent by a second access device is received.

In step S212, first measurement gap information is sent to the second access device based on the request information.

In some embodiments, after generating the measurement gap configuration of the dual-connectivity UE, the first access device may send the first measurement gap information to the second access device according to the measurement gap configuration of the dual-connectivity UE.

In another embodiment, only when the second access device requests the corresponding measurement gap configuration, based on the request information sent by the second access device, the first access device may send the first measurement gap information to the second access device based on the measurement gap configuration of the first access device for the dual-connectivity UE.

If the first access device actively sends the first measurement gap information to the second access device, the first measurement gap information may be sent to the second access device through one set of messages or one signaling. In this way, when the second access device has a measurement gap configuration for the dual-connectivity UE, if the first access device has completed the measurement gap configuration for the dual-connectivity UE, then the second access device has already received and stored the first measurement gap information sent by the first access device.

If the first access device sends the first measurement gap information based on current request information sent by the second access device, the first access device will send the first measurement gap information to the second access device, that is, the second access device will obtain the first measurement gap information from the first access device only when there is a need.

In some embodiments, the step S220 may include: receiving the second measurement gap information sent by the second access device after a measurement gap configuration for the dual-connectivity UE is generated.

As shown in FIG. 4B, an embodiment of the present disclosure provides an information processing method, which is performed by a first access device, and the method may include the following steps.

In step S213, request information is sent to a second access device.

In step S214, second measurement gap configuration sent based on the request information is received.

In some embodiments, after the second access device generates the measurement gap configuration for the dual-connectivity UE, it will automatically send the second measurement gap information to the first access device. In this way, as long as the second access device generates or updates the measurement gap configuration for the dual-connectivity UE, the first access device will receive the second measurement gap information. In this way, when the first access device generates the measurement gap configuration for the dual-connectivity UE, it may generate the measurement gap configuration based on the second measurement gap information.

In some cases, the second measurement gap information may be returned by the second access device based on the request information sent by the first access device.

In some embodiments, the measurement gap information includes: a number of sets of measurement gap configurations.

If the measurement gap information includes at least the number of sets of measurement gap configurations, the number of sets of the measurement gap configurations configured by the first access device and the second access device for the dual-connectivity UE may be made not exceed the total number of sets supported by the dual-connectivity UE.

The measurement gap information further includes a measurement gap configuration.

The measurement gap configuration includes at least one of the following:
a period;
a duration; or
an offset.

The period of the measurement gap configuration may be used to determine the period of the measurement gap.

The duration herein is the time length of one measurement gap.

The offset may be used by the dual-connectivity UE to determine the first starting moment of the measurement gap. For example, the offset may be a time difference of the first starting moment of the measurement gap relative to a starting moment of one wireless frame or subframe or the measurement gap configuration issued by a base station.

If the measurement gap information includes the measurement gap configuration, an opposite-end access device generates a measurement gap configuration configured for the opposite-end access device, for the same dual-connectivity UE, according to the measurement gap configuration carried in the measurement gap information.

The measurement gap configuration may be sent by the access device to the dual-connectivity UE via radio resource control (RRC) signaling or a media access control (MAC) control element (CE).

As shown in FIG. 5A, an embodiment of the present disclosure provides an information processing method, which is performed by a first access device, and the information processing method may include the following steps.

In step S310: second measurement gap information is received.

In step S320: if the second measurement gap information is received before generating a measurement gap configuration for a dual-connectivity UE, the measurement gap configuration for the dual-connectivity UE is generated according to the second measurement gap information.

In some embodiments, generating the measurement gap configuration for the dual-connectivity UE according to the second measurement gap information includes:

generating Z sets of measurement gap configurations for the dual-connectivity UE if the second measurement gap information indicates that the second access device configures Y sets of measurement gap configurations for the dual-connectivity UE, where a sum of Y and Z is less than or equal to a total number of sets X of measurement gap configurations supported by the dual-connectivity UE.

The total number of sets configured by the first access device and the second access device is less than or equal to X, then the total number of sets of measurement gaps of the same dual-connectivity UE will not exceed the total number of sets supported by the dual-connectivity UE, so that the exception caused by the total number of sets of measurement gaps configured for the dual-connectivity UE by the first access device and the second access device exceeding the total number of sets of measurement gaps supported by the UE, can be avoided.

As shown in FIG. 5B, an embodiment of the present disclosure provides an information processing method, which is performed by a first access device, and the information processing method may include the following steps.

In step S330: if second measurement gap information of a second access device for a dual-connectivity UE is received after generating a measurement gap configuration of the dual-connectivity UE, a sum of a number of sets Z of measurement gap configurations of the first access device for the dual-connectivity UE and a number of sets Y of measurement gap configurations of the second access device for the dual-connectivity UE is compared with a total number of sets X of measurement gap configurations supported by the dual-connectivity UE.

In step S340: when the sum of Y and Z is greater than X, it is determined whether to update the measurement gap configuration for the dual-connectivity UE.

If the sum of Y and Z is greater than X, the dual-connectivity UE will be unable to execute each set of measurement gap configuration, which results in a configuration exception.

If such exception that the sum of Y and Z is greater than X occurs, at least one access device has to update the measurement gap configuration for the dual-connectivity UE.

In an embodiment, determining whether to update the measurement gap configuration for the dual-connectivity UE when the sum of Y and Z is greater than X includes:
determining to update the measurement gap configuration for the dual-connectivity UE if the first access device is an access device of a primary secondary cell of the dual-connectivity UE;
or,
determining not to update the measurement gap configuration for the dual-connectivity UE if the first access device is an access device of a primary cell of the dual-connectivity UE.

That is, when X is less than the sum of Y and Z, it is determined to update the measurement gap configuration generated by the access device of the primary secondary cell to which the dual-connectivity UE is connected. Therefore, when the first access device is the access device of the primary cell, there is no need to update the measurement gap configuration generated by the first access device for the dual-connectivity UE. If the first access device is the access device of the primary secondary cell, it is necessary to update the measurement gap configuration generated by the first access device for the dual-connectivity UE.

In some embodiments, the method further includes:

generating less than or equal to X-Y sets of measurement gap configurations for the dual-connectivity UE if it is determined to update the measurement gap configuration for the dual-connectivity UE.

If the number of sets of measurement gaps generated by the second access device and the first access device for the same dual-connectivity UE is greater than the maximum number of sets of measurement gap configurations supported by the dual-connectivity UE, and it is determined that the first access device updates the measurement gap configuration, or the first access device itself has a need to update the measurement gap configuration of the dual-connectivity UE, then less than or equal to X-Y sets of measurement gap configurations are generated for the dual-connectivity UE based on Y and X.

In some embodiments, performing communication of the measurement gap information for the dual-connectivity user equipment (UE) with the second access device includes:
performing communication of the measurement gap information for the dual-connectivity UE with the second access device via an Xn interface;
or,
performing communication of the measurement gap information for the dual-connectivity UE with the second access device via an NG interface.

In some embodiments, the measurement gap information is communicated between the first access device and the second access device via the Xn interface, that is, the measurement gap information is communicated between the first access device and the second access device via an air interface, which has the characteristic of high communication efficiency.

In some other embodiments, the first access device and the second access device exchange the measurement gap information via the NG interface, which can also realize mutual communication of the measurement gap information between the first access device and the second access device.

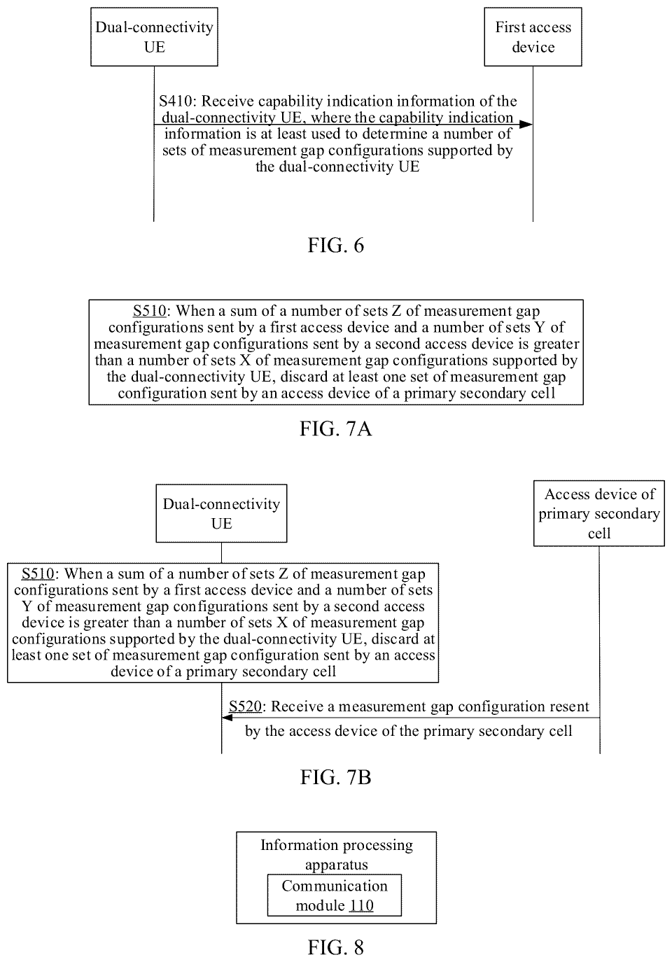

As shown in FIG. 6, an embodiment of the present disclosure provides an information processing method, which is performed by a first access device, and the method further includes the following.

In step S410, capability indication information of the dual-connectivity UE is received, where the capability indication information is at least used to determine a number of sets of measurement gap configurations supported by the dual-connectivity UE.

The information processing method provided in this embodiment of the present disclosure may be implemented in combination with the information processing methods performed by the first access device in any of the aforementioned embodiments, or may be implemented separately.

The capability indication information provided in the embodiment of the present disclosure at least indicates the number of sets of measurement gaps supported by the dual-connectivity UE. In this way, the first access device can configure the measurement gaps for the dual-connectivity UE according to the number of sets of measurement gaps supported by the dual-connectivity UE, and at least the number of sets of measurement gaps configured for the dual-connectivity UE does not exceed the maximum number of sets of measurement gaps supported by the dual-connectivity UE.

In an embodiment, the first access device is an access device of a primary cell of the dual-connectivity UE, and the second access device is an access device of a primary secondary cell of the dual-connectivity UE;

or,
the first access device is the access device of the primary secondary cell of the dual-connectivity UE, and the second access device is the access device of the primary cell of the dual-connectivity UE.

As shown in FIG. 7A, an embodiment of the present disclosure provides an information processing method, which is performed by a dual-connectivity UE, and the method includes the following.

In step S510, when a sum of a number of sets Z of measurement gap configurations sent by a first access device and a number of sets Y of measurement gap configurations sent by a second access device is greater than a number of sets X of measurement gap configurations supported by the dual-connectivity UE, at least one set of measurement gap configuration sent by an access device of a primary secondary cell is discarded.

When the number of sets of measurement gap configurations configured for dual-connectivity UE by two or more access devices connected to the UE exceeds the maximum number of sets supported by UE, UE will discard at least one set of measurement gap configuration.

When the UE discards at least one set of measurement gap configuration, it will discard at least one set of measurement gap configuration of the primary secondary cell. In this way, at least it is ensured that the measurement gap configuration of the primary cell is not discarded by UE, and it can ensure that the dual-connectivity UE performs measurements of SSB and/or CSI-RS according to the measurement gap configuration of the access device of the primary cell, thereby realizing the operations of the dual-connectivity UE, such as cell handover, cell reselection and/or beam switching.

X herein may be: the total number of sets of the independent measurement gap configurations supported by UE, or, the total number of sets of the independent measurement gap configurations and shared measurement gap configurations supported by UE.

In some embodiments, as shown in FIG. 7B, the method further includes the following.

In step S520, a measurement gap configuration resent by the access device of the primary secondary cell is received; where a number of sets of measurement gap configurations resent by the access device of the primary secondary cell is less than or equal to a difference between the number of sets of measurement gap configurations supported by the dual-connectivity UE and a number of sets of measurement gap configurations of an access device of a primary cell for the dual-connectivity UE.

In some other embodiments, the method includes:
sending capability indication information to the first access device and the second access device, where the capability indication information is at least used to determine the number of sets of measurement gap configurations supported by the dual-connectivity UE.

The embodiments of the present disclosure provide a method for configuring a measurement gap in an MR-DC scenario. The PCell or PSCell indicates the respective configured measurement gap information through an Xn/NG interface to configure a suitable number of sets of measurement gaps and configuration information for a terminal.

An embodiment of the present disclosure provides an information processing method, where the method includes the following.

In step 1, UE reports capability indication information of a number of sets X of independent measurement gaps that the terminal can support to a network through a measurement and mobility capability related parameter information unit (IE MeasAndMobParametersMRDC) signaling, where X is a positive integer greater than or equal to 1.

When a PCell configures the measurement gap earlier than a PSCell configuring the measurement gap, step 2 is performed.

In step 2, the PCell configures Y sets of independent measurement gaps for the UE via RRC signaling, where Y is a positive integer greater than or equal to 1 and less than X.

In step 3, the PCell indicates to the PSCell, via an Xn/NG interface, measurement gap information configured by the PCell for the UE. The indication information includes at least the following information:
a number of sets Y of the independent measurement gaps; and
configuration information for each set of independent measurement gap, including a period, a duration, and an offset.

In step 4, the PSCell configures Z sets of measurement gaps for the UE via RRC signaling according to the indication information of measurement gap configuration of PCell and the capability information of the supported number (X) of measurement gaps, where Z is a positive integer less than or equal to X minus Y.

When the PSCell configures the measurement gap earlier than the PSCell configuring the measurement gap, step 5 is performed.

In step 5, the PSCell configures Y sets of independent measurement gaps for the UE via RRC signaling, where Y is a positive integer greater than or equal to 1 and less than X.

In step 6, the PSCell indicates to the PCell, via an Xn/NG interface, the measurement gap information configured by the PSCell for the UE. The indication information includes at least the following information:
a number of sets Y of the independent measurement gaps; and
configuration information for each set of independent measurement gap, including a period, a duration, and an offset.

In step 7, the PCell configures Z sets of measurement gaps for the UE via RRC signaling according to the indication information of measurement gap configuration of PSCell and the capability information of the supported number (X) of measurement gaps, where Z is a positive integer less than or equal to X minus Y.

When the PCell and PSCell configure measurement gaps simultaneously, step 8 is performed.

In step 8, the PCell and the PSCell configure Y and Z sets of independent measurement gaps for the UE respectively via RRC signaling, where Y and Z are positive integers greater than or equal to 1 and less than X.

In step 9, the PCell and the PSCell indicate the measurement gap information configured for the UE to the PSCell and the PCell respectively via an Xn/NG interface. The indication information includes at least the following information:
a number of sets Y or Z of the independent measurement gaps; and
configuration information for each set of measurement gap, including a period, a duration, and an offset.

In step 10, when the value of Y+Z is less than or equal to the value of X, the UE performs the measurement gaps of PCell and PSCell respectively. When the value of Y+Z is greater than the value of X, the UE first performs the Y sets of measurement gaps configured by the PCell, and then performs X-Y sets of measurement gaps.

In step 11, the PSCell reconfigures X-Y sets of measurement gaps via the RRC reconfiguration message and the step 9 is repeated.

In summary, the embodiments of the present disclosure provide a method for configuring a measurement gap for an MR-DC UE. The PCell or the PSCell indicates the respective configured measurement gap information through the Xn/NG interface to configure an appropriate number of sets of measurement gaps and configuration information for the terminal.

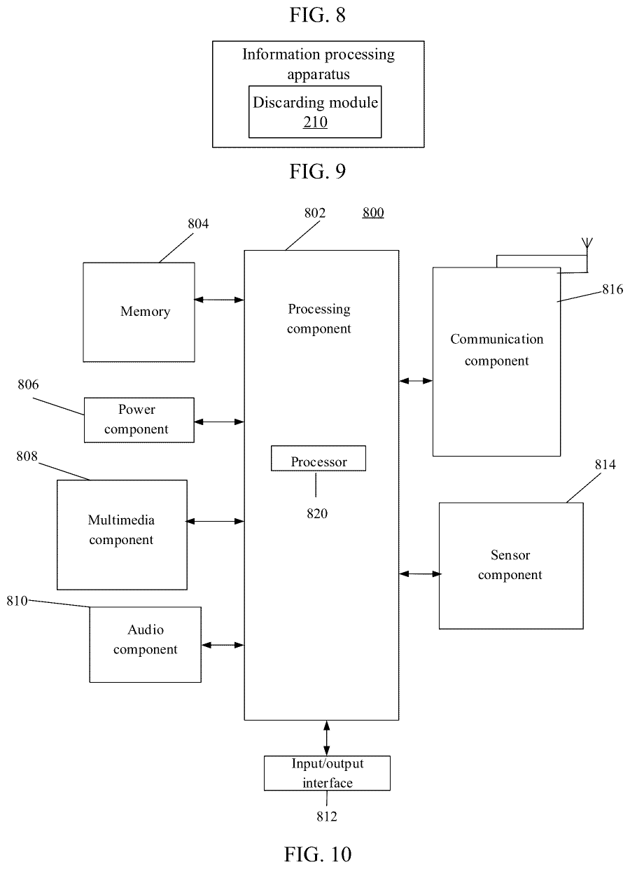

As shown in FIG. 8, an embodiment of the present disclosure provides an information processing apparatus, where the apparatus includes:
a communication module 110, configured to perform communication of measurement gap information for a dual-connectivity user equipment (UE) with a second access device.

The information processing apparatus may be included in a first access device.

In some embodiments, the communication module 110 may be a program module; after the program module is executed by a processor, it can realize the communication of the measurement gap information for the dual-connectivity UE with the second access device.

In other embodiments, the communication module 110 may be a module combining software and hardware. The module combining software and hardware includes, but is not limited to: various programmable arrays, and the programmable array includes, but is not limited to: a field programmable array and/or a complex programmable array.

In some other embodiments, the communication module 110 may also include: a pure hardware module, where the pure hardware module includes, but is not limited to: a dedicated integrated circuit.

In some embodiments, the communication module 110 includes at least one of the following:
a first sending unit, configured to send first measurement gap information of a first access device for the dual-connectivity UE to the second access device; or
a first receiving unit, configured to receive second measurement gap information of the second access device for the dual-connectivity UE.

In some embodiments, the first sending unit is configured to send the first measurement gap information to the second access device after generating a measurement gap configuration for the dual-connectivity UE; or, configured to receive request information sent by the second access device, and send the first measurement gap information to the second access device based on the request information.

In some embodiments, the first receiving unit is configured to receive the second measurement gap information sent by the second access device after a measurement gap configuration for the dual-connectivity UE is generated; or configured to send request information to the second access device, and receive a second measurement gap configuration sent based on the request information.

In some embodiments, the measurement gap information includes:
a number of sets of measurement gap configurations.

In some embodiments, the measurement gap information further includes the measurement gap configuration;
where the measurement gap configuration includes at least one of the following:
a period;
a duration; or
an offset.

In some embodiments, the apparatus further includes:
a first generating module, configured to generate the measurement gap configuration for the dual-connectivity UE according to the second measurement gap information if the second measurement gap information is received before generating the measurement gap configuration for the dual-connectivity UE.

In some embodiments, the first generation module is configured to generate Z sets of measurement gap configurations for the dual-connectivity UE if the second measurement gap information indicates that the second access device configures Y sets of measurement gap configurations for the dual-connectivity UE, where a sum of Y and Z is less than or equal to a total number of sets X of measurement gap configurations supported by the dual-connectivity UE.

In some embodiments, the total number of sets X of independent gap configurations supported by the dual-connectivity UE is pre-configured or specified by a protocol.

In some embodiments, the apparatus further includes:
a first determining module, configured to compare a sum of a number of sets Z of measurement gap configurations of the first access device for the dual-connectivity UE and a number of sets Y of measurement gap configurations of the second access device for the dual-connectivity UE with a total number of sets X of measurement gap configurations supported by the dual-connectivity UE, if the second measurement gap information of the second access device for the dual-connectivity UE is received after generating the measurement gap configuration for the dual-connectivity UE; and
a second determining module, configured to determine whether to update the measurement gap configuration for the dual-connectivity UE if the sum of Y and Z is greater than X.

In some embodiments, the second determination module is configured to determine to update the measurement gap configuration for the dual-connectivity UE if the first access device is an access device of a primary secondary cell of the dual-connectivity UE; or, determine not to update the measurement gap configuration for the dual-connectivity UE if the first access device is an access device of a primary cell of the dual-connectivity UE.

In some embodiments, the apparatus further includes:
a second generating module, configured to generate less than or equal to X-Y sets of measurement gap configurations for the dual-connectivity UE according to Y and X, if it is determined to update the measurement gap configuration for the dual-connectivity UE.

In some embodiments, the communication module 110 is configured to perform communication of the measurement gap information for the dual-connectivity UE with the second access device via an Xn interface; or to perform communication of the measurement gap information for the dual-connectivity UE with the second access device via an NG interface.

In some embodiments, the apparatus further includes:
a first receiving module, configured to receive capability indication information of the dual-connectivity UE, where the capability indication information is at least used to determine a number of sets of measurement gap configurations supported by the dual-connectivity UE.

In some embodiments, the first access device is an access device of a primary cell of the dual-connectivity UE, and the second access device is an access device of a primary secondary cell of the dual-connectivity UE;
or,
the first access device is the access device of the primary secondary cell of the dual-connectivity UE, and the second access device is the access device of the primary cell of the dual-connectivity UE.

As shown in FIG. 9, an embodiment of the present disclosure provides an information processing apparatus, where the apparatus includes:
a discarding module 210, configured to discard at least one set of measurement gap configuration sent by an access device of a primary secondary cell, when a sum of a number of sets Z of measurement gap configurations sent by a first access device and a number of sets Y of measurement gap configurations sent by a second access device is greater than a number of sets X of measurement gap configurations supported by a dual-connectivity UE.

In some embodiments, the information processing apparatus may be included in the dual-connectivity UE.

In some embodiments, the discarding module 210 may be a program module; after the program module is executed by a processor, it can implement the discard of the redundant measurement gap configuration.

In other embodiments, the discarding module 210 may be a module combining software and hardware. The module combining software and hardware includes, but is not limited to: various programmable arrays, and the programmable array includes, but is not limited to: a field programmable array and/or a complex programmable array.

In some other embodiments, the discarding module 210 may also include: a pure hardware module, where the pure hardware module includes, but is not limited to: a dedicated integrated circuit.

In some embodiments, the apparatus further includes:
a second receiving module, configured to receive a measurement gap configuration resent by the access device of the primary secondary cell; where a number of sets of measurement gap configurations resent by the access device of the primary secondary cell is less than or equal to a difference between the number of sets of measurement gap configurations supported by the dual-connectivity UE and a number of sets of measurement gap configurations of an access device of a primary cell for the dual-connectivity UE.

In some embodiments, the apparatus includes:
a sending module, configured to send capability indication information to the first access device and the second access device, where the capability indication information is at least used to determine the number of sets of measurement gap configurations supported by the dual-connectivity UE.

The present disclosure provides a communication device, including:
a memory for storing-executable instructions of a processor;
the processor, connected to the memory;
where the processor is configured to execute the information processing method provided by any of the aforementioned technical solutions.

The processor may include various types of storage media, which are non-transitory computer storage media capable of continuing to memorize the information stored thereon after the communication device is powered down.

The communication device herein includes: a UE or a first access device.

The processor may be connected to the memory via a bus, etc., and is used to read the executable program stored in the memory, for example, at least one of the methods shown in any one of FIGS. 2, 3A, 3B, 4A, 4B, 5A, 5B, 6 and 7A to 7B.

FIG. 10 is a block diagram of a UE 800 according to an exemplary embodiment. For example, the UE 800 may be a mobile phone, a computer, a digital broadcast user device, a messaging device, a gaming console, a tablet, a medical device, exercise equipment, a personal digital assistant, and the like.

Referring to FIG. 10, the UE 800 may include one or more of the following components: a processing component 802, a memory 804, a power component 806, a multimedia component 808, an audio component 810, an input/output (I/O) interface 812, a sensor component 814, and a communication component 816.

The processing component 802 typically controls overall operation of the UE 800, such as the operations associated with display, telephone calls, data communications, camera operations, and recording operations. The processing component 802 may include one or more processors 820 to execute instructions to generate all or part of the steps of the above described methods. Moreover, the processing component 802 may include one or more modules which facilitate the interaction between the processing component 802 and other components. For instance, the processing component 802 may include a multimedia module to facilitate the interaction between the multimedia component 808 and the processing component 802.

The memory 804 is configured to store various types of data to support the operation of the UE 800. Examples of such data include instructions for any applications or methods operated on the UE 800, contact data, phonebook data, messages, pictures, videos, etc. The memory 804 may be implemented using any type of volatile or non-volatile memory devices or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 806 provides power to various components of the UE 800. The power component 806 may include a power management system, one or more power sources, and any other components associated with the generation, management, and distribution of power in the UE 800.

The multimedia component 808 includes a screen providing an output interface between the UE 800 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 808 includes a front camera and/or a rear camera. The front camera and/or the rear camera may receive an external multimedia datum while the UE 800 is in an operation mode, such as a photographing mode or a video mode. Each of the front camera and the rear camera may be a fixed optical lens system or have focus and optical zoom capability.

The audio component 810 is configured to output and/or input audio signals. For example, the audio component 810 includes a microphone (MIC) configured to receive an external audio signal when the UE 800 is in an operation mode, such as a call mode, a recording mode, and a voice recognition mode. The received audio signal may be further stored in the memory 804 or transmitted via the communication component 816. In some embodiments, the audio component 810 further includes a speaker to output audio signals.

The I/O interface 812 provides an interface between the processing component 802 and peripheral interface modules, such as a keyboard, a click wheel, buttons, and the like. The buttons may include, but are not limited to, a home button, a volume button, a starting button, and a locking button.

The sensor component 814 includes one or more sensors to provide status assessments of various aspects of the UE 800. For instance, the sensor component 814 may detect an open/closed status of the UE 800, relative positioning of components, e.g., the display and the keypad, of the UE 800, a change in position of the UE 800 or a component of the UE 800, a presence or absence of user contact with the UE 800, an orientation or an acceleration/deceleration of the UE 800, and a change in temperature of the UE 800. The sensor component 814 may include a proximity sensor configured to detect the presence of nearby objects without any physical contact. The sensor component 814 may also include a light sensor, such as a CMOS or CCD image sensor, for use in imaging applications. In some embodiments, the sensor component 814 may also include an acceleration sensor, a gyroscope sensor, a magnetic sensor, a pressure sensor, or a temperature sensor.

The communication component 816 is configured to facilitate communication, wired or wirelessly, between the UE 800 and other devices. The UE 800 can access a wireless network based on a communication standard, such as WiFi, 2G or 3G, or a combination thereof. In one exemplary embodiment, the communication component 816 receives a broadcast signal or broadcast associated information from an external broadcast management system via a broadcast channel. In one exemplary embodiment, the communication component 816 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the UE 800 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer-readable storage medium including instructions, such as included in the memory 804, executable by the processor 820 in the UE 800, for generating the above methods. For example, the non-transitory computer-readable storage medium may be a ROM, a random access memory (RAM), a CD-ROM, a magnetic tape, a floppy disc, an optical data storage device, and the like.

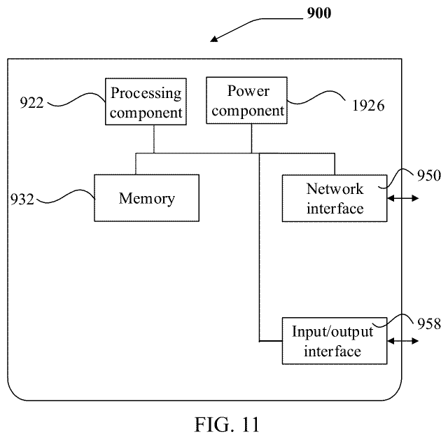

As shown in FIG. 11, an embodiment of the present disclosure illustrates a structure of an access device. For example, the communication device 900 may be provided as the aforementioned first access device and/or second access device.

Referring to FIG. 11, the communication device 900 includes a processing component 922, which further includes one or more processors, and a memory resource represented by a memory 932 for storing instructions executable by the processing component 922, such as an application program. The application program stored in the memory 932 may include one or more modules, each corresponding to a set of instructions. In addition, the processing component 922 is configured to execute instructions to perform any of the aforementioned methods applied to the access device, for example, the methods shown in any of FIGS. 2, 3A, 3B, 4A, 4B, 5A, 5B, 6, and 7A to 7B.

The communication device 900 may further include a power component 926 configured to perform power management of the communication device 900, a wired or wireless network interface 950 configured to connect the communication device 900 to a network, and an input/output (I/O) interface 958. The communication device 900 may operate based on an operating system stored in the memory 932, such as a Windows Server™, a Mac OS X™, a Unix™, a Linux™, a Free BSD™ or the like.

Those skilled in the art will readily appreciate other implementation solutions of the present disclosure after considering the specification and practicing the disclosure disclosed herein. The present disclosure is intended to cover any variations, uses or adaptations of the present disclosure that follow the general principles of the present disclosure and include common knowledge or customary technical means in the art that are not disclosed in the present disclosure. The specification and the embodiments are considered exemplary only, and the true scope and spirit of the present disclosure are indicated by the appending claims.

It should be understood that the present disclosure is not limited to the exact structures that have been described above and shown in the accompanying drawings, and various modifications and changes may be made without departing from the scope thereof. The scope of the present disclosure is limited only by the appended claims.

1. An information processing method, wherein the method is performed by a first access device, and the method comprises:
performing communication of measurement gap information for a dual-connectivity user equipment (UE) with a second access device.

2. The method according to claim 1, wherein performing communication of the measurement gap information for the dual-connectivity user equipment (UE) with the second access device comprises at least one of:
sending first measurement gap information of the first access device for the dual-connectivity UE to the second access device; or
receiving second measurement gap information of the second access device for the dual-connectivity UE.

3. The method according to claim 2, wherein sending the first measurement gap information of the first access device for the dual-connectivity UE to the second access device comprises:
sending the first measurement gap information to the second access device after generating a measurement gap configuration for the dual-connectivity UE;
or,
receiving request information sent by the second access device, and sending the first measurement gap information to the second access device based on the request information,
wherein receiving the second measurement gap information of the second access device for the dual-connectivity UE comprises:
receiving the second measurement gap information sent by the second access device after generating a measurement gap configuration for the dual-connectivity UE; or
sending request information to the second access device, and receiving a second measurement gap information sent based on the request information.

4. (canceled)

5. The method according to claim 1, wherein the measurement gap information comprises:
a number of sets of measurement gap configurations,
wherein the measurement gap information further comprises the measurement gap configuration;
wherein the measurement gap configuration comprises at least one of:
a period;
a duration; or
an offset.

6. (canceled)

7. The method according to claim 1, wherein the method further comprises:
in response to receiving second measurement gap information before generating a measurement gap configuration for the dual-connectivity UE, generating the measurement gap configuration for the dual-connectivity UE according to the second measurement gap information,
wherein generating the measurement gap configuration for the dual-connectivity UE according to the second measurement gap information comprises:
generating Z sets of measurement gap configurations for the dual-connectivity UE in response to that the second measurement gap information indicates that the second access device configures Y sets of measurement gap configurations for the dual-connectivity UE, wherein a sum of Y and Z is less than or equal to a total number of sets X of measurement gap configurations supported by the dual-connectivity UE.

8. (canceled)

9. The method according to claim 1, wherein the method further comprises:
in response to receiving second measurement gap information of the second access device for the dual-connectivity UE after generating a measurement gap configuration for the dual-connectivity UE, comparing a sum of a number of sets Z of measurement gap configurations of the first access device for the dual-connectivity UE and a number of sets Y of measurement gap configurations of the second access device for the dual-connectivity UE with a total number of sets X of measurement gap configurations supported by the dual-connectivity UE; and
determining whether to update the measurement gap configuration for the dual-connectivity UE in response to the sum of Y and Z being greater than X,
wherein determining whether to update the measurement gap configuration for the dual-connectivity UE in response to the sum of Y and Z being greater than X comprises:
determining to update the measurement gap configuration for the dual-connectivity UE in response to that the first access device is an access device of a primary secondary cell of the dual-connectivity UE; or
determining not to update the measurement gap configuration for the dual-connectivity UE in response to that the first access device is an access device of a primary cell of the dual-connectivity UE,
wherein the method further comprises:
generating less than or equal to X-Y sets of measurement gap configurations for the dual-connectivity UE in response to determining to update the measurement gap configuration for the dual-connectivity UE.

10.-11. (canceled)

12. The method according to claim 1, wherein performing communication of the measurement gap information for the dual-connectivity user equipment (UE) with the second access device comprises:
performing communication of the measurement gap information for the dual-connectivity UE with the second access device via an Xn interface;
or,
performing communication of the measurement gap information for the dual-connectivity UE with the second access device via an NG interface.

13. The method according to claim 1, wherein the method further comprises:
receiving capability indication information of the dual-connectivity UE, wherein the capability indication information is at least used to determine a number of sets of measurement gap configurations supported by the dual-connectivity UE.

14. The method according to claim 1, wherein,
the first access device is an access device of a primary cell of the dual-connectivity UE, and the second access device is an access device of a primary secondary cell of the dual-connectivity UE;
or,
the first access device is the access device of the primary secondary cell of the dual-connectivity UE, and the second access device is the access device of the primary cell of the dual-connectivity UE.

15. An information processing method, wherein the method is performed by a dual-connectivity UE, and the method comprises:
in response to a sum of a number of sets Z of measurement gap configurations sent by a first access device and a number of sets Y of measurement gap configurations sent by a second access device being greater than a number of sets X of measurement gap configurations supported by the dual-connectivity UE, discarding at least one set of measurement gap configuration sent by an access device of a primary secondary cell.

16. The method according to claim 15, wherein the method further comprises:
receiving a measurement gap configuration resent by the access device of the primary secondary cell; wherein a number of sets of measurement gap configurations resent by the access device of the primary secondary cell is less than or equal to a difference between the number of sets of measurement gap configurations supported by the dual-connectivity UE and a number of sets of measurement gap configurations of an access device of a primary cell for the dual-connectivity UE.

17. The method according to claim 15- or 16, wherein the method comprises:
sending capability indication information to the first access device and the second access device, wherein the capability indication information is at least used to determine the number of sets of measurement gap configurations supported by the dual-connectivity UE.

18. An information processing apparatus,
comprising a processor, a transceiver, a memory, and an executable program stored in the memory and capable of being run by the processor, wherein when running the executable program, the processor is configured to perform communication of measurement gap information for a dual-connectivity user equipment (UE) with a second access device.

19. The apparatus according to claim 18, wherein the processor is further configured to perform at least one of:
sending first measurement gap information of a first access device for the dual-connectivity UE to the second access device; or
receiving second measurement gap information of the second access device for the dual-connectivity UE.

20. The apparatus according to claim 19, wherein the processor is further configured to send the first measurement gap information to the second access device after generating a measurement gap configuration for the dual-connectivity UE; or, configured to receive request information sent by the second access device, and send the first measurement gap information to the second access device based on the request information,
wherein the processor is configured to receive the second measurement gap information sent by the second access device after generating a measurement gap configuration for the dual-connectivity UE; or configured to send request information to the second access device, and receive a second measurement gap information sent based on the request information.

21. (canceled)

22. The apparatus according to claim 18, wherein the measurement gap information comprises:
a number of sets of measurement gap configurations.

23. (canceled)

24. The apparatus according to claim 18, wherein the processor is further configured to:
in response to receiving second measurement gap information before generating a measurement gap configuration for the dual-connectivity UE, generate the measurement gap configuration for the dual-connectivity UE according to the second measurement gap information,
wherein the processor is further configured to generate Z sets of measurement gap configurations for the dual-connectivity UE in response to that the second measurement gap information indicates that the second access device configures Y sets of measurement gap configurations for the dual-connectivity UE, wherein a sum of Y and Z is less than or equal to a total number of sets X of measurement gap configurations supported by the dual-connectivity UE.

25. (canceled)

26. The apparatus according to claim 18, wherein the processor is further configured to:
in response to receiving second measurement gap information of the second access device for the dual-connectivity UE after generating a measurement gap configuration for the dual-connectivity UE, compare a sum of a number of sets Z of measurement gap configurations of the first access device for the dual-connectivity UE and a number of sets Y of measurement gap configurations of the second access device for the dual-connectivity UE with a total number of sets X of measurement gap configurations supported by the dual-connectivity UE; and
determine whether to update the measurement gap configuration for the dual-connectivity UE in response to the sum of Y and Z being greater than X,
wherein the processor is further configured to determine to update the measurement gap configuration for the dual-connectivity UE in response to that the first access device is an access device of a primary secondary cell of the dual-connectivity UE; or, determine not to update the measurement gap configuration for the dual-connectivity UE in response to that the first access device is an access device of a primary cell of the dual-connectivity UE,
wherein the processor is further configured to:
generate less than or equal to X-Y sets of measurement gap configurations for the dual-connectivity UE according to Y and X, in response to determining to update the measurement gap configuration for the dual-connectivity UE.

27.-28. (canceled)

29. The apparatus according to claim 18, wherein the processor is further configured to perform communication of the measurement gap information for the dual-connectivity UE with the second access device via an Xn interface; or to perform communication of the measurement gap information for the dual-connectivity UE with the second access device via an NG interface.

30. The apparatus according to claim 18, wherein the processor is further configured to:
receive capability indication information of the dual-connectivity UE, wherein the capability indication information is at least used to determine a number of sets of measurement gap configurations supported by the dual-connectivity UE.

31.-36. (canceled)
